(19) United States
(12) Patent Application Publication
(10) Pub. No.: US 2012/0023396 A1
(43) Pub. Date: Jan. 26, 2012

(54) METHOD, APPARATUS, AND STORAGE MEDIA FOR PARSING INPUT STRINGS

(76) Inventors: Nicholas Wright MILLER, Albany, NY (US); Matthew WELLS, Toronto (CA)

(21) Appl. No.: 12/843,083

(22) Filed: Jul. 26, 2010

(51) Int. Cl. G06F 17/00

(52) U.S. Cl. 715/234

(57) ABSTRACT

A computer includes a memory area and a processor that is coupled to the memory area. The processor is configured to receive a document as an input string comprised of a markup language, store the input string in the memory area, parse the input string, and deserialize the input string to generate an object model, wherein the object model includes at least one type and at least one value corresponding to the at least one type. The processor is also configured to store the object model in the memory area.

### BACKGROUND

The embodiments described herein relate generally to processing data strings and, more particularly, to processing data strings into an object model that is suitable for use in subsequent workflow activities.

At least some known systems use process method parameters that support serialization of a string, such as an Extensible Markup Language (XML) string. Moreover, at least some known systems use the Business to Manufacturing Markup Language (B2mML) standard when processing such XML strings. The B2mML standard is a large and complex set of XML schema documents (XSD) that complicates processing of B2mML documents. However, at least some known systems merely transfer raw XML strings between applications and/or computers, which requires multiple attempts to process and validate the data within the raw XML strings and causes such systems to perform more slowly.

Moreover, at least some known systems perform such processing using custom techniques that are not or cannot be applied to multiple systems. For example, a first system may use a custom technique that addresses specific known issues to process a raw XML string, and a second system may use a different custom technique that addresses a different issue to process the same raw XML string. However, using multiple custom processing techniques to process the same raw XML string requires additional maintenance and testing, which increases the time to develop and deploy such systems.

### BRIEF DESCRIPTION

In one aspect, a method includes receiving a document as an input string, parsing the input string using a computer, and deserializing the input string using the computer to generate an object model. The object model includes at least one type and at least one value corresponding to the at least one type. The method also includes displaying the object model to a user via a display device.

In another aspect, a computer includes a memory area and a processor that is coupled to the memory area. The processor is configured to receive a document as an input string comprised of a markup language, store the input string in the memory area, parse the input string, and deserialize the input string to generate an object model, wherein the object model includes at least one type and at least one value corresponding to the at least one type. The processor is also configured to store the object model in the memory.

In another aspect, one or more computer-readable storage media include computer-executable components including a serialization component that when executed by at least one processor causes the processor to deserialize an Extensible Markup Language (XML) input string, and a parsing component that when executed by at least one processor causes the processor to parse the input string into at least one type and at least one value and to generate an object model based on the at least one type and the at least one value.

### BRIEF DESCRIPTION OF THE DRAWINGS

The embodiments described herein may be better understood by referring to the following description in conjunction with the accompanying drawings.

FIG. 1 is a functional block diagram of an exemplary enterprise resource planning (ERP) system.

FIG. 2 is a simplified network block diagram of the ERP system shown in FIG. 1.

FIG. 3 is a flowchart that illustrates an exemplary method of transforming a B2mML document into a workflow object model that may be used with subsequent workflow activities by the ERP system shown in FIGS. 1 and 2.

### DETAILED DESCRIPTION

Exemplary embodiments of methods, apparatus, and computer-readable storage media for use in parsing an input string representative of a document into an object model for use by any suitable application or apparatus are described herein. The embodiments described herein facilitate tying business-level computer systems to factory-level computer systems for use in tracking personnel, materials, workflow data, and/or assembly data of products.

An exemplary technical effect of the methods, apparatus, and computer-readable storage media described herein include at least one of: (a) receiving an Extensible Markup Language (XML) document as an input string; (b) parsing and deserializing the input string into an object model by detecting types and corresponding values within the input string and linking the types and values; (c) extracting the types and the corresponding values from the object model; (d) inserting the extracted types and corresponding values into a form and displaying the form using a display device; and (e) binding the values as inputs to other systems, such as schedule systems, automation equipment, and the like.

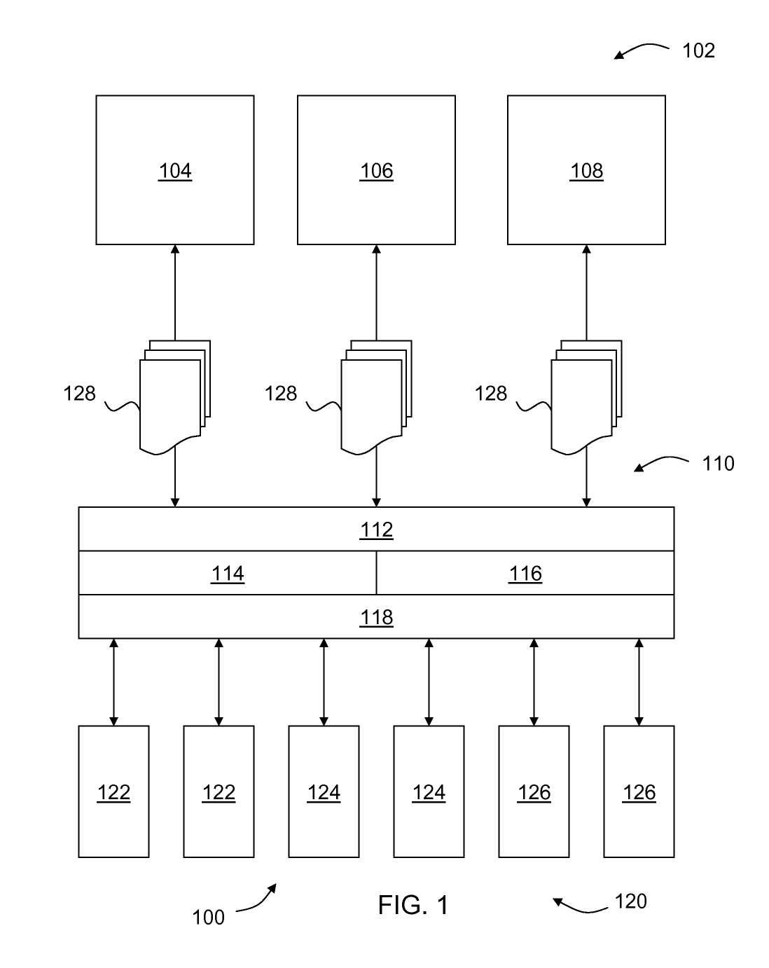

FIG. 1 is a functional block diagram of an exemplary enterprise resource planning (ERP) system 100 for use within, for example, an automation system (not shown). System 100 includes one or more enterprise applications 102, such as a personnel knowledge application 104, an equipment knowledge application 106, and a materials tracking application 108. System 100 also includes one or more middle tier application layers 110, such as a production management layer 112, a system event layer 114, a production data layer 116, and a system workflow layer 118. Furthermore, system 100 includes one or more sub-system applications 120, such as automation applications 122, high-speed data archiving applications 124, and product assembly tracking applications 126.

Enterprise applications 102 and middle tier application layers 110 communicate by sending and receiving documents 128 in the form of a markup language. An exemplary markup language that may be used to represent the data within a document is Extensible Markup Language (XML). However, it should be noted that any markup language may be used that enables system 100 to operate as described herein. In the exemplary embodiment, documents 128 are Business to Manufacturing Markup Language (B2mML) documents that implement the ISA-95 standard and use a set of XML Schema Language Documents (XSD).

As described in greater detail below, middle tier application layers 110 process documents 128 such that the data within documents 128 are more easily used in workflow activities by sub-system applications 120.

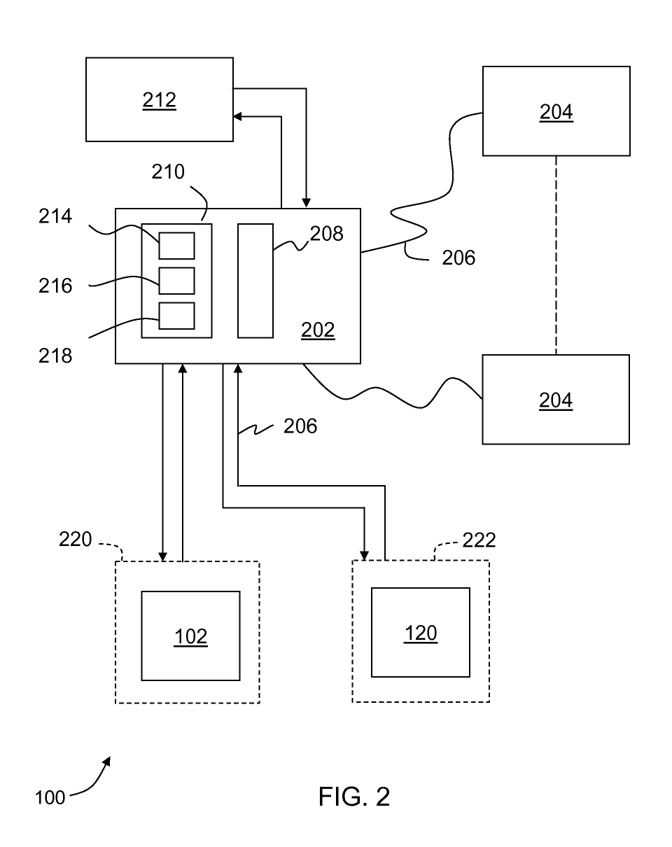

FIG. 2 is a simplified network block diagram of ERP system 100 in accordance with one embodiment. In the exemplary embodiment, system 100 includes at least one server system 202, and one or more client sub-systems, also referred to as client systems 204, connected to server system 202. In one embodiment, client systems 204 are computers including a web browser and/or a client software application that displays data and/or workflow information to a user via a display device (not shown). Server system 202 is accessible to client systems 204 over a network 206, such as the Internet and/or an intranet. Client systems 204 are interconnected to network 206 through many interfaces including a local area network (LAN), a wide area network (WAN), dial-in-connections, cable modems, wireless modems, and/or special high-speed Integrated Services Digital Network (ISDN) lines. As described above, client systems 204 may be any device capable of interconnecting to network 206 including a computer, a web-based phone, a personal digital assistant (PDA) device, or any suitable web-based connectable equipment.

In the exemplary embodiment, server system 202 hosts middle tier applications 110 (shown in FIG. 1). Server system 202 includes a processor 208 and a memory area 210. A secondary memory area 212 is coupled to server system 202, and is capable of storing information on a variety of matters, such as data related to facility workflow, material inventory, and/or personnel and equipment scheduling. In one embodiment, secondary memory area 212 is centralized and is stored on server system 202 such that secondary memory area 212 is accessed by potential users at one of client systems 204 by logging onto server system 202 through one of client systems 204. In an alternative embodiment, secondary memory area 212 is stored remotely from server system 202 and may be non-centralized. In some embodiments, memory area 210 includes computer-executable program modules or components that include computer-executable components. Exemplary components include a serialization component 214, a parsing component 216, and a form component 218. However, additional components not described herein may be used to augment the functionality of components 214, 216, and 218 by, for example, communicating with network 206.

In the exemplary embodiment, system 100 also includes at least one enterprise server system 220 that hosts enterprise applications 102, and at least one application server system 222 that hosts sub-system applications 120. Enterprise server system 220 and application server system 222 each communicate with server system 202 via network 206. In some embodiments, server system 202 also hosts sub-system applications 120 and/or enterprise applications 102.

The embodiments illustrated and described herein as well as embodiments not specifically described herein but within the scope of aspects of the invention constitute exemplary means for parsing B2mML documents, and more particularly, constitute exemplary means for transforming B2mML documents into workflow object models that may be used with subsequent workflow activities. For example, server system 202 or client system 204, or any other similar computer device, programmed with computer-executable instructions illustrated in FIG. 2 constitutes exemplary means for transforming B2mML documents into workflow object models that may be used with subsequent workflow activities.

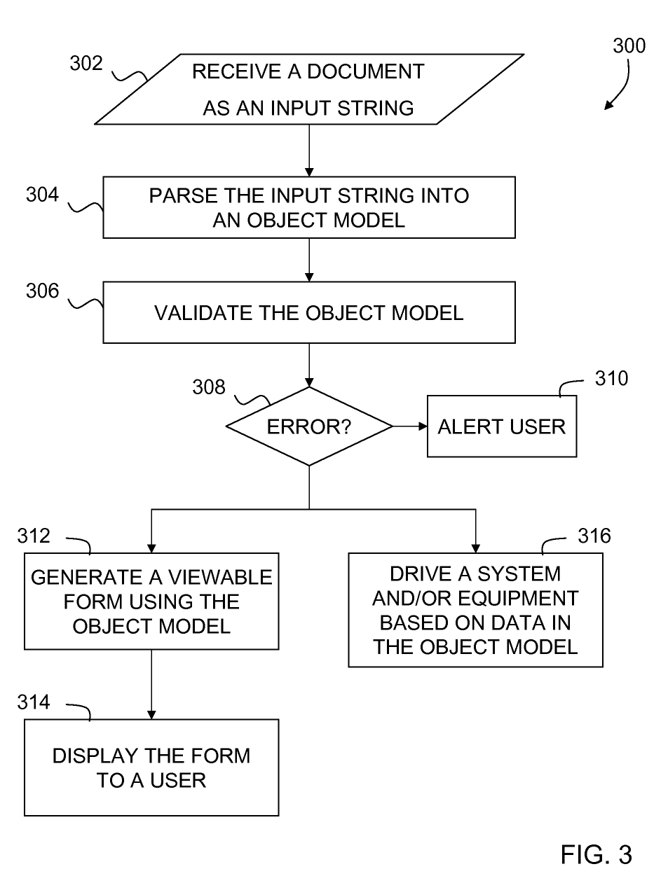

FIG. 3 is a flowchart 300 that illustrates an exemplary method of transforming a B2mML document, such as document 128 (shown in FIG. 1), into a workflow object model that may be used with subsequent workflow activities by system 100 (shown in FIGS. 1 and 2).

In the exemplary embodiment, server system 102 (shown in FIG. 2) receives 302 document 128 from enterprise server system 220 (shown in FIG. 2) as an input string. Document 128 may originate in any enterprise application 102, such as personnel knowledge application 104, equipment knowledge application 106, or materials tracking application 108 (each shown in FIG. 1). In the exemplary embodiment, document 128 includes a workflow schedule that is formatted in XML.

In the exemplary embodiment, server system 202 parses 304 the input string to generate an object model. To generate the object model, server system 202 deserializes the input string using, for example, a programming framework such as the Microsoft.NET framework. It should be understood that XML serialization is a process for converting strongly typed objects, such as document 128, into an XML stream that conforms to a specific XML Schema Definition language document. In addition, XML deserialization is a process for converting an XML stream into an object. In the exemplary embodiment, server system 202 declares a variable, and deserializes the input string into the variable. Deserialization may include one more nested loops for workflow schedule items or workflow schedule requests to detect empty fields and to insert a default value into the empty fields. Server system 202 then serializes the variable into an output string. During deserialization and serialization, server system 202 does not alter the values of the variable except for inserting default values into empty fields. In some embodiments, server system 202 deserializes the input string and serializes the variable based on instructions of serialization component 214 (shown in FIG. 2). For example, serialization component 214 causes processor 208 (shown in FIG. 2) to deserialize the input string and serialize the variable into the output string.

Moreover, server system 202 processes the output string, and detects one or more type fields within the output string that are each associated with a corresponding value field. Server system 202 parses the output string by separating each pair of type and value, and binding the pair to each other within the object model. In some embodiments, server system 202 parses the output string based on instructions of parsing component 216 (shown in FIG. 2). For example, parsing component 216 causes processor 208 to parse the output string to generate the object model. In the exemplary embodiment, server system 202 validates 306 the object model. For example, server system 202 detects when the object model includes a workflow request that relates to a specific material, and determines whether the material is stocked at a sufficient amount. If server system 202 detects 308 an error during validation, server system 202 alerts 310 a user via a display device. The user may then repair the broken link or data error. Moreover, server system 202 can bind values in the object model directly to inputs of sub-system application 120 (shown in FIG. 1), such as a supply chain notification or ordering system, that is hosted by an application server system 222 (shown in FIG. 2) to automatically order the material from a vendor to be delivered on a given date and/or to a given location.

Furthermore, in the exemplary embodiment, server system 202 generates 312 a viewable and modifiable form by processing the object model. Server system 202 processes the object model and detects each pair of type and value. For each type, server system 202 extracts the type from the pair and inserts the type into the form as a label. For each value that is associated with the type, server system 202 extracts the value and inserts the value into the form as an appropriate value based on the type. For example, a type may be a date, a time such as a process start time or end time, a process status, a comment, or any other suitable type of data that may be displayed via the form. A value depends on the type, and may include a date in a preselected form, a time value, a text string that represents a comment type, or any other suitable data value. In addition, server system 202 displays 314 the form to a user via a client system 104 (shown in FIG. 2). In some embodiments, server system 202 generates 312 the form based on instructions of form component 218 (shown in FIG. 2). For example, form component 218 causes processor 208 to generate the form and to control display of the form as described above.

In addition, server system 202 may use individual values within the object model to drive 316 operation of sub-system applications 120, such as automation applications 122, high-speed data archiving applications 124, and product assembly tracking applications 126 (each shown in FIG. 1). For example, server system 202 may use a process start time value within the object model to drive automation application 122 and/or a particular piece of equipment. Similarly, server system 202 may use a value associated with a particular type within the object model as input to a particular piece of equipment.

Exemplary embodiments of methods, apparatus, and computer-readable storage media for transforming a B2mML document into a workflow object model that may be used with subsequent workflow activities by an ERP system are described above in detail. The methods, apparatus, and computer-readable storage media are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer, such as those described herein, includes at least one processor or processing unit and at least one form of system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary automation workflow system environment, embodiments of the invention are operational with numerous other general purpose or special purpose system environments or configurations. The automation workflow system environment is not intended to suggest any limitation as to the scope of use or functionality of any aspect of the invention. Moreover, the automation workflow system environment should not be interpreted as having any dependency or requirement relating to any one or combination of components illustrated in the exemplary operating environment. Examples of well known systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits, and any other circuit or processor capable of executing the functions described herein. The above examples are exemplary only, and thus are not intended to limit in any way the definition and/or meaning of the term processor.

In some embodiments, the term “memory area” refers generally to any collection of data including a database, such as a hierarchical database, a relational database, a flat file database, an object-relational database, an object oriented database, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
receiving a document as an input string;
parsing the input string using a computer;
deserializing the input string using the computer to generate an object model, the object model including at least one type and at least one value corresponding to the at least one type; and
displaying the object model to a user via a display device.

2. The method of claim 1, wherein receiving comprises receiving an Extensible Markup Language (XML) document.

3. The method of claim 1, wherein deserializing the input string comprises:
declaring a variable;
detecting the at least one type within the input string;
detecting the at least one value within the input string;
linking the at least one value with the at least one type within the variable; and
storing the variable in a memory area.

4. The method of claim 3, wherein the at least one type includes a plurality of types and the at least one value includes a plurality of values, each value of the plurality of values associated with a corresponding type of the plurality of types, said deserializing the input string further comprises:
detecting each value; and
linking each value to the corresponding type within the variable.

5. The method of claim 3, further comprising serializing the variable into an output string.

6. The method of claim 5, wherein parsing the input string comprises parsing the output string into the object model.

7. The method of claim 1, wherein displaying the object model comprises populating a viewable form using the object model and displaying the viewable form via the display device.

8. The method of claim 7, wherein populating a viewable form comprises:
extracting the at least one type from the object model;
inserting the at least one type into the viewable form as a label;
extracting the at least one value from the object model; and
inserting the at least one value into the viewable form as a modifiable value associated with the label.

9. A computer comprising:
a memory area configured to store data representative of an automation process; and
a processor coupled to said memory area and configured to:
receive a document as an input string comprised of a markup language relating to the automation process;
store the input string in said memory area;
parse the input string;
deserialize the input string to generate an object model, the object model including at least one type and at least one value corresponding to the at least one type; and
store the object model in said memory area.

10. The computer of claim 9, wherein said processor is configured to deserialize the input string by:
declaring a variable;
detecting the at least one type within the input string;
detecting the at least one value within the input string;
linking the at least one value with the at least one type within the variable; and
storing the variable in said memory area.

11. The computer of claim 10, wherein the at least one type includes a plurality of types and the at least one value includes a plurality of values, each value of the plurality of values associated with a corresponding type of the plurality of types, said processor is further configured to:
detect each value; and
link each value to the corresponding type within the variable.

12. The computer of claim 10, wherein said processor is further configured to serialize the variable into an output string.

13. The computer of claim 12, wherein said processor is further configured to parse the output string into the object model.

14. The computer of claim 9, further comprising a display device, said processor is further configured to generate a viewable form using the object model and to display the viewable form via said display device.

15. The computer of claim 14, wherein said processor is further configured to:
extract the at least one type from the object model;
insert the at least one type into the viewable form as a label;
extract the at least one value from the object model; and
insert the at least one value into the viewable form as a modifiable value associated with the label.

16. One or more computer-readable storage media having computer-executable components, said components comprising
a serialization component that when executed by at least one processor causes the at least one processor to deserialize an Extensible Markup Language (XML) input string; and
a parsing component that when executed by at least one processor causes the at least one processor to parse the input string into at least one type and at least one value and to generate an object model based on the at least one type and the at least one value.

17. The computer-readable storage media of claim 16, wherein said serialization component causes the at least one processor to:
declare a variable;
detect the at least one type within the input string;
detect the at least one value within the input string;
link the at least one value with the at least one type within the variable; and
store the variable in a memory area.

18. The computer-readable storage media of claim 17, wherein said serialization component causes the at least one processor to serialize the variable into an output string.

19. The computer-readable storage media of claim 18, wherein said parsing component causes the at least one processor to parse the output string into the object model.

20. The computer-readable storage media of claim 16, further comprising a form component that when executed by at least one processor causes the at least one processor to generate a form based on the object model and to cause a display device to display the form to a user.
